(19) United States
(12) Patent Application Publication
(10) Pub. No.: US 2025/0245160 A1
(43) Pub. Date: Jul. 31, 2025

(54) Fine-Grained Memory Aware Cache Prefetch

(71) Applicant: Advanced Micro Devices, Inc., Santa Clara, CA (US)

(72) Inventors: Marko Scrbak, Dripping Springs, TX (US); Jagadish B. Kotra, Austin, TX (US); Chetana N Keltcher, Lexington, MA (US)

(73) Assignee: Advanced Micro Devices, Inc., Santa Clara, CA (US)

(21) Appl. No.: 18/428,905

(22) Filed: Jan. 31, 2024

(51) Int. Cl. G06F 12/0862; G06F 12/02; G06F 12/1027

(52) U.S. Cl. CPC G06F 12/0862; G06F 12/0292; G06F 12/1027

(57) ABSTRACT

A fine-grained memory aware cache prefetch is described. In one or more implementations, a processor includes a cache. The cache includes one or more cache lines that each include one or more sub-cache lines. The processor also includes a side buffer configured to store prefetched sub-cache line data for storage in the one or more sub-cache lines. The processor also includes a fine-grained memory aware prefetcher associated with the cache. The fine-grained memory aware prefetcher includes fine-grained prefetch logic that, when executed, causes the fine-grained memory aware prefetcher to generate a fine-grained prefetch request directed to a fine-grained memory. The fine-grained prefetch request identifying data to be prefetched from the fine-grained memory. Responsive to the fine-grained prefetch request, the fine-grained memory aware prefetcher receives the data from the fine-grained memory and stores the data in the side buffer as the prefetched sub-cache line data for retrieval by the cache.

### BACKGROUND

A hardware prefetcher, integrated within modern processors, functions as a forward-thinking mechanism designed to predict and fetch, in advance, the data or instructions to be used by a processor (e.g., a central processing unit or “CPU”) in the near future. By bridging the gap between the processor and the memory, a prefetcher attempts to reduce the latency associated with accessing main memory. The prefetcher achieves this by continuously observing memory access patterns. Once the prefetcher discerns a consistent or repetitive pattern, such as sequential or strided memory accesses, the prefetcher proactively retrieves the anticipated data, placing the data into a proximate cache, often the level 2 (L2) or level 3 (L3) caches. This ensures that when the processor eventually requests the data, the data is readily available, thereby streamlining processing and improving system performance and efficiency.

### BRIEF DESCRIPTION OF THE DRAWINGS

FIG. 1 is a block diagram of a non-limiting example system to implement fine-grained memory aware cache prefetch.

FIG. 2 is a block diagram of a non-limiting example in which fine-grained prefetch logic issues fine-grained prefetch requests to a fine-grained memory.

FIG. 3 is a block diagram of a non-limiting example in which a fine-grained training logic expands a prefetcher training table to include fields for an atom offset, an atom size, and an atom mode.

FIG. 4 depicts several examples where different 8 byte accesses are detected by various prefetchers with extended fine-grained memory support.

FIG. 5 depicts an example graph and example arrays associated with a dynamic atom fetch granularity use case.

FIG. 6 depicts a procedure in a non-limiting example implementation of fine-grained memory aware cache prefetch.

FIG. 7 depicts a procedure in another non-limiting example implementation of fine-grained memory aware cache prefetch.

FIG. 8 depicts a procedure in another non-limiting example implementation of fine-grained memory aware cache prefetch.

### DETAILED DESCRIPTION

### Overview

Next generation memory technologies, such as stacked dynamic random access memory (DRAM) and upcoming ultra-dense ferroelectric RAM (FeRAM) memory arrays support fine grain architectures that enable accessing sub-cache line granular data chunks (i.e., a few bytes referred to as an “atom”) for better energy efficiency and increased bandwidth. Typical atom sizes supported by these memory technologies are 4 bytes, 8 bytes, and 16 bytes. Modern computing elements, like central processing units (CPUs) and graphics processing units (GPUs), operate in a grain-agnostic manner and still rely on prefetching techniques that operate at cache line granularity. Since conventional cache lines hold 64 bytes of data, existing prefetch mechanisms are unable to exploit the benefits of fine grain memory architectures that utilize sub-cache line granularity.

The techniques disclosed herein are directed to a prefetcher that is aware of fine grain memory architectures. In other words, the described prefetcher is configured to fetch chunks of data that are smaller than a conventional cache line (i.e., less than 64 bytes). These smaller chunks of data are referred to herein as “atoms.” Moreover, rather than prefetching data for an entire cache line, the described prefetcher fetches atom-sized data that fits inside logical subdivisions of conventional cache lines. These logical subdivisions are referred to herein as “sub-cache lines.” In this manner, the described prefetcher enables energy-efficient and high bandwidth prefetches for targeting prefetch data that is stored in atom-sized data chunks in a fine-grained memory, such as fine-grained dynamic random access memory or FG-DRAM.

In one or more implementations, the described prefetcher targets primarily irregular workloads, such as those that originate from graph applications and applications with memory access patterns that resemble accessing arrays of pointers. These workloads have an access granularity that is typically less than 64 bytes. By prefetching data in atom-sized data chunks that are less than 64 bytes, the described prefetcher is capable of more efficiently prefetching data for processing irregular workloads.

In one or more implementations, the described prefetcher is configured to perform fine-grained or sub-cache line training for non-temporal memory regions. In doing so, the prefetcher avoids complexity and issues from tracking fine-grained coherency and caching at a granularity of less than 64 bytes required in conventional computing elements like CPUs. As will be described in greater detail herein, the prefetcher uses training logic extended to train on non-temporal accesses. Currently, conventional prefetchers do not train on non-temporal accesses and instead rely on cache hit/miss information for temporal accesses.

Data prefetched by the prefetcher is stored in a side buffer. In one or more implementations, the side buffer is depicted as part of a cache system that includes a cache hierarchy of multiple cache levels, such as level 1 cache, level 2 cache, and a last level or level 3 cache. The side buffer is deployed, in some implementations, before a memory controller and after a coherency point of the system. When the side buffer is deployed in this manner, changes to the existing cache hierarchy are not required. This enables the described prefetcher and side buffer to be deployed into existing systems without expensive changes to the existing cache hierarchy.

In some aspects, the techniques described herein relate to a processor including: a cache including one or more cache lines, and the one or more cache lines including one or more sub-cache lines, a side buffer associated with the cache, the side buffer configured to store prefetched sub-cache line data for storage in the one or more sub-cache lines, and a fine-grained memory aware prefetcher configured to: generate a fine-grained prefetch request identifying data to be prefetched from a fine-grained memory, responsive to the fine-grained prefetch request, receive the data from the fine-grained memory, and store the data in the side buffer as the prefetched sub-cache line data for retrieval by the cache.

In some aspects, the techniques described herein relate to a processor, wherein the cache includes a cache hierarchy including a level 1 cache, a level 2 cache, and a last level cache.

In some aspects, the techniques described herein relate to a processor, wherein the side buffer is deployed between the fine-grained memory and the last level cache.

In some aspects, the techniques described herein relate to a processor, wherein the prefetched sub-cache line data includes a prefetched atom.

In some aspects, the techniques described herein relate to a processor, wherein the prefetched atom has an atom size that is less than 64 bytes.

In some aspects, the techniques described herein relate to a processor, wherein the fine-grained prefetch request identifies the atom size based on a size of the one or more sub-cache lines.

In some aspects, the techniques described herein relate to a processor, wherein the fine-grained memory aware prefetcher is further configured to: select a load instruction associated with the data to be prefetched, perform a cache lookup in the cache for a physical address associated with the load instruction, perform a side buffer lookup in the side buffer for the physical address associated with the load instruction, and responsive to a hit in the cache lookup or the side buffer lookup, perform a prefetcher training table lookup in a prefetcher training table.

In some aspects, the techniques described herein relate to a processor, wherein the fine-grained memory aware prefetcher is further configured to, responsive to a hit in the prefetcher training table lookup, updating an entry in the prefetcher training table.

In some aspects, the techniques described herein relate to a processor, wherein the fine-grained memory aware prefetcher is further configured to, responsive to a miss in the prefetcher training table lookup, allocating a new table entry in the prefetcher training table.

In some aspects, the techniques described herein relate to a system including: a fine-grained memory, and a prefetcher configured to: generate a fine-grained prefetch request identifying data to be prefetched from the fine-grained memory, responsive to the fine-grained prefetch request, receive the data from the fine-grained memory, and store the data in a side buffer for retrieval by a cache.

In some aspects, the techniques described herein relate to a system, further including a processor including the side buffer, the cache, and the prefetcher, the cache including a cache hierarchy.

In some aspects, the techniques described herein relate to a system, wherein the side buffer is deployed between the fine-grained memory and a last level cache of the cache hierarchy.

In some aspects, the techniques described herein relate to a system, wherein the data includes a prefetched atom.

In some aspects, the techniques described herein relate to a system, wherein the prefetched atom has an atom size that is less than 64 bytes.

In some aspects, the techniques described herein relate to a system, wherein the fine-grained prefetch request identifies the atom size based on a size of a sub-cache line within the cache.

In some aspects, the techniques described herein relate to a system, wherein the prefetcher is further configured to: select a load instruction associated with the data to be prefetched, perform a cache lookup in the cache for a physical address associated with the load instruction, perform a side buffer lookup in the side buffer for the physical address associated with the load instruction, and responsive to a hit in the cache lookup or the side buffer lookup, perform a prefetcher training table lookup in a prefetcher training table.

In some aspects, the techniques described herein relate to a system, wherein the prefetcher is further configured to, responsive to a hit in the prefetcher training table lookup, update an entry in the prefetcher training table.

In some aspects, the techniques described herein relate to a system, wherein the prefetcher is further configured to, responsive to a miss in the prefetcher training table lookup, allocating a new table entry in the prefetcher training table.

In some aspects, the techniques described herein relate to a method including: generating, by a prefetcher, a fine-grained prefetch request identifying data to be prefetched from a fine-grained memory, responsive to the fine-grained prefetch request, receiving, by the prefetcher, the data from the fine-grained memory, and storing, by the prefetcher, the data in a side buffer as prefetched sub-cache line data for retrieval by a cache.

In some aspects, the techniques described herein relate to a method, further including: selecting, by the prefetcher, a load instruction associated with the data to be prefetched, performing, by the prefetcher, a cache lookup in the cache for a physical address associated with the load instruction, performing, by the prefetcher, a side buffer lookup in the side buffer for the physical address associated with the load instruction, responsive to a hit in the cache lookup or the side buffer lookup, performing, by the prefetcher, a prefetcher training table lookup in a prefetcher training table, responsive to a hit in the prefetcher training table lookup, updating, by the prefetcher, an entry in the prefetcher training table, and responsive to a miss in the prefetcher training table lookup, allocating, by the prefetcher, a new table entry in the prefetcher training table.

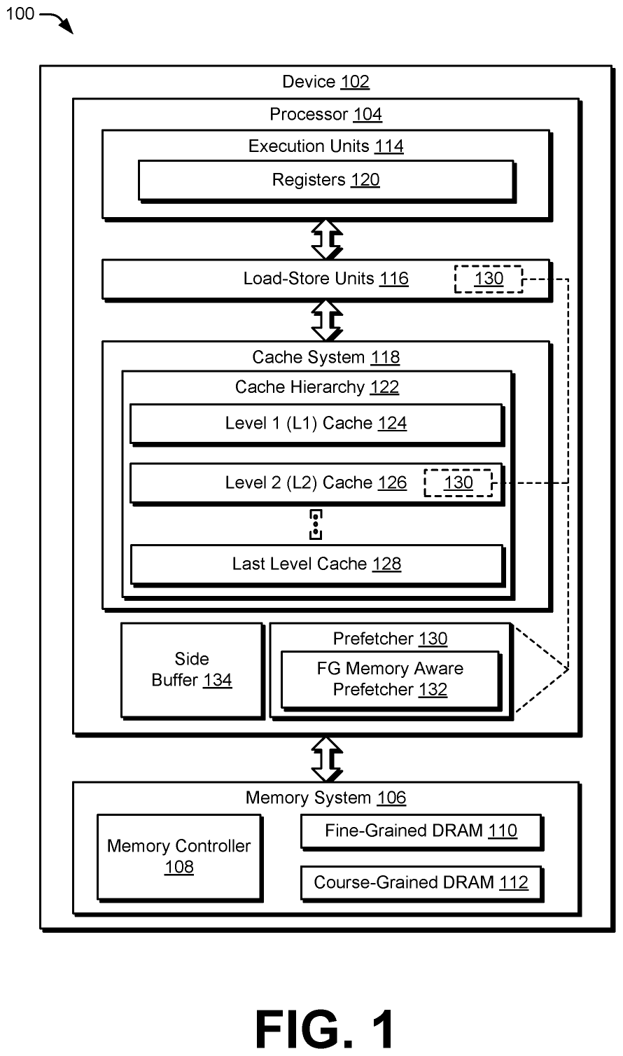

FIG. 1 is a block diagram of a non-limiting example system 100 configured to implement fine-grained memory aware cache prefetches. The system 100 includes a device 102 having a processor 104, and a memory system 106 having a memory controller 108, a fine-grained DRAM or FG-DRAM 110, and a course-grained DRAM or CG-DRAM 112.

The device 102 is configurable in a variety of ways. Examples of the device 102 include, by way of example and not limitation, computing devices, servers, mobile devices (e.g., wearables, mobile phones, tablets, and laptops), processors (e.g., graphics processing units, central processing units, and accelerators), digital signal processors, disk array controllers, hard disk drive host adapters, memory cards, solid-state drives, wireless communications hardware connections, Ethernet hardware connections, switches, bridges, network interface controllers, and other apparatus configurations. It is to be appreciated that in various implementations, the device 102 is configured as any one or more of those devices listed just above and/or a variety of other devices without departing from the spirit or scope of the described techniques.

In accordance with the described techniques, the processor 104 and the memory system 106 are coupled to one another via one or more wired and/or wireless connections. Example wired connections include, but are not limited to, buses (e.g., a data bus), interconnects, traces, and planes. The processor 104 is an electronic circuit that reads, translates, and executes requests of a program, e.g., an application, operating system, virtual machine, container, and so on. Examples of the processor 104 include, but are not limited to including, central processing units (CPUs), graphics processing units (GPUs), Field Programmable Gate Arrays (FPGAs), Application Specific Integrated Circuits (ASICs), digital signal processors (DSPs), and accelerator devices.

Although not specifically depicted in the illustrated example, the memory system 106 includes, in some implementations, volatile memory and non-volatile memory. The volatile memory and the non-volatile memory are devices and/or systems that are used to store information, such as for use by the processor 104. Broadly, the volatile memory retains data as long as the device 102 is connected to power, and the data is accessible relatively faster than the non-volatile memory. Examples of the volatile memory include random-access memory (RAM), dynamic random-access memory (DRAM), synchronous dynamic random-access memory (SDRAM), and static random-access memory (SRAM). Further, the non-volatile memory retains data even after the device 102 is disconnected from power but is accessible relatively slower than the volatile memory. Examples of the non-volatile memory include solid state disks (SSD), flash memory, read-only memory (ROM), programmable read-only memory (PROM), erasable programmable read-only memory (EPROM), and electronically erasable programmable read-only memory (EEPROM).

The memory controller 108 is configured to receive requests from the processor 104. Although depicted in the example system 100 as being implemented separately from the processor 104, in some implementations, the memory controller 108 is implemented locally as part of the processor 104. The memory controller 108 is further configured to schedule requests for multiple processors 104, despite being depicted in the illustrated example of FIG. 1 as serving a single processor 104. For instance, in an example implementation, the memory controller 108 schedules requests for a plurality of different processors 104, where each of the plurality of different processors includes one or more cores that submit requests to the memory controller 108 for scheduling with the memory, such as the FG-DRAM 110 and/or the CG-DRAM 112.

In accordance with one or more implementations, the memory controller 108 is associated with a single channel of memory. For instance, the system 100 is configured to include a plurality of different memory controllers 108, one for each of a plurality of channels of the memory system 106. In some implementations, a single channel in the memory system 106 is allocated into multiple pseudo-channels. In such implementations, the memory controller 108 is configured to schedule requests for different pseudo-channels of a single channel in the memory system 106.

In the illustrated example, the volatile memory of the memory system 106 is depicted, specifically, as a fine-grained DRAM (FG-DRAM) 110 and a course-grained DRAM (CG-DRAM) 112. The CG-DRAM 112 operates with a relatively large granularity at the rank or bank level. The FG-DRAM 110 uses a reduced granularity, which allow for smaller portions (e.g., sub-banks, sub-rows, or even individual cells) to be accessed independently.

As shown, the processor 104 includes one or more execution units 114, one or more load-store units 116, and a cache system 118 that are coupled to one another via one or more wired and/or wireless connections. Broadly, an execution unit 114 is representative of functionality implemented in hardware of the processor 104 to perform specific types of operations, such as arithmetic and logic operations. Further, a load-store unit 116 is representative of functionality implemented in hardware of the processor 104 to perform load operations and store operations. More specifically, the execution units 114 and the load-store units 116 perform respective operations based on requests received through execution of software programs, e.g., applications, operating systems, virtual machines, containers, and so on. By way of example, requests are generated and forwarded to the execution units 114 and/or the load-store units 116 by a control unit (not depicted) of the processor 104.

Load requests instruct the load-store units 116 to load data from the cache system 118, the volatile memory (e.g., the FG-DRAM 110 and/or the CG-DRAM 112), and/or the non-volatile memory into registers 120 of the one or more execution units 114. Once loaded into the registers 120, requests (e.g., arithmetic and logic requests) are executable by the execution units 114 to perform corresponding operations (e.g., arithmetic and logic operations) on the data that is present in the registers 120. Store requests instruct the load-store units 116 to store data from the registers 120 (e.g., after the data has been processed by the execution units 114) back to the cache system 118, the volatile memory (e.g., the FG-DRAM 110 and/or the CG-DRAM 112), and/or the non-volatile memory. Load requests and store requests issued by the load-store units 116 as part of executing a runtime program are referred to herein collectively as “demand requests.”

As shown, the cache system 118 includes multiple hardware cache levels as part of a cache hierarchy 122, examples of which are illustrated as a level 1 (L1) cache 124, a level 2 (L2) cache 126, and a last level cache 128. By way of example, the processor 104 is a multi-core processor, and each respective core includes an L1 cache 124 and an L2 cache 126 that are private to a respective core of the processor 104. Furthermore, the processor 104 includes a last level cache 128 that is shared among the multiple cores of the processor 104. Broadly, the higher cache levels in the cache hierarchy 122 are accessible (e.g., for loading and/or storing data) relatively faster than the lower cache levels in the cache hierarchy 122, but the lower cache levels have increased memory capacity than the higher cache levels in the cache hierarchy 122. It is to be appreciated that the cache system 118 of the processor 104 includes differing numbers of caches and different hierarchical structures without departing from the spirit or scope of the described techniques.

Furthermore, the cache system 118 is accessible (e.g., for loading and/or storing data) relatively faster than data stored in the memory system 106. In sum, the various memory sources of the processor 104 are ordered from fastest access speed to slowest access speed in the following order: (1) the L1 cache 124, (2) the L2 cache 126, (3) the last level cache 128, (4) the volatile memory, such as the FG-DRAM 110 and the CG-DRAM 112, and (5) the non-volatile memory (not depicted). Given the above, a load-store unit 116 executes a load request that includes a memory address by progressively checking the memory sources for the data identified by the memory address in the aforementioned order. If the data is present in a memory source, the load-store unit 116 loads the data from the memory source into the registers 120, and if not, the load-store unit 116 proceeds to checking whether the data is present in the next memory source of the aforementioned order.

An example implementation of the FG-DRAM 110 is derived from a modified HBM architecture. In baseline HBM4, for example, a bank is composed of multiple arrays of sixteen 512×512 mats, and a 1024 byte row is spread across these sixteen mats. A 32 byte atom is read from sixteen mats over two internal cycles and fed into a 64-bit input/output (I/O) interface. In the FG-DRAM 110, for example, the bank is divided into four grains by segmenting the master wordline (MWL). The grains are further divided into two pseudo-banks. Each grain is connected to a private 16-bit I/O interface (i.e., 4× narrower than the baseline). The FG-DRAM 110 increases parallelism by 4× and requests are issued to each grain independently which the described techniques leverage to issue fine-grain aware cache prefetches.

Some current hardware and software prefetchers operate on a 64 byte cache line granularity. This is also the native cache line size in most modern CPUs. To exploit the benefits of fine-grained support in memories, such as the FG-DRAM 110, the described fine-grain aware prefetch mechanisms operate on sub-cache line granularity (e.g., 8 byte, 16 byte, or 32 byte atoms). In addition, as will be described in detail below, changes to a conventional cache hierarchy are implemented to enable tracking prefetched data on a sub-cache line granular basis.

As shown, the processor 104 includes a prefetcher 130 which is representative of functionality implemented in hardware of the processor 104 to prefetch data that is predicted to be used (e.g., in the near future) by a workload of a runtime program. To do so, the prefetcher 130 monitors memory access patterns of the workload, predicts which memory addresses are likely to be accessed based on the observed memory access patterns, and issues prefetch requests to fetch data of the predicted memory address from a slower memory source in terms of access speed (e.g., the last level cache 128, the FG-DRAM 110, or the CG-DRAM 112) into a faster memory source in terms of access speed (e.g., the L2 cache 126). Examples of the prefetcher 130 include, but are not limited to including, stream prefetchers, sequential prefetchers, stride prefetchers, adjacent line prefetchers, Markov prefetchers, spatial prefetchers, striding pointer prefetchers, and temporal prefetchers. In one or more implementations, the prefetcher 130 is located at the L2 cache, the load-store units 116, or both.

The described techniques implement a special purpose prefetcher to prefetch data specifically from the FG-DRAM 110. This special purpose prefetcher is depicted as an FG memory aware prefetcher 132. In the illustrated example, the FG memory aware prefetcher 132 is implemented as part of the prefetcher 130. In other words, the FG memory aware prefetcher 132 is implemented in addition to or as an extension of another prefetcher such as those described immediately above. Alternatively, the FG memory aware prefetcher 132 is a standalone prefetcher which is implemented independent of one or more other prefetchers 130 within the processor 104 architecture.

The FG memory aware prefetcher 132 targets primarily irregular workloads, such as those that originate from graph applications and applications with memory access patterns that resemble accessing arrays of pointers. These workloads also have an access granularity that is typically less than 64 bytes (i.e., the size of a conventional cache line).

In one or more implementations, the FG memory aware prefetcher 132 is configured to perform sub-cache line training for non-temporal memory regions to avoid any complexity/issues from tracking fine-grained coherency and caching at a granularity of less than a cache line size, such as 32 bytes, 64 bytes, or 128 bytes. As will be described in greater detail below, the FG memory aware prefetcher 132 uses training logic extended to train on non-temporal accesses. Currently, conventional prefetchers do not train on non-temporal accesses and instead rely on cache hit/miss information for temporal accesses.

The FG memory aware prefetcher 132 is further configured to issue prefetch requests specific to sub-cache line prefetches (e.g., <cache line size, such as 32 bytes, 64 bytes, or 128 bytes). These prefetches are marked as non-temporal and include an additional field describing the size of the atom. For example, the additional field includes up to two bits used to encode four potential atom sizes—4 bytes, 8 bytes, 16 bytes, and 32 bytes. For full-size prefetches (e.g., 32 bytes, 64 bytes, 128 bytes, or other full cache line size), the prefetches are marked as non-temporal if it is a prefetch to a non-temporal region, and regular prefetches follow a conventional flow.

Data prefetched by the FG memory aware prefetcher 132 is stored in a side buffer 134. In the illustrated example, the side buffer 134 is depicted as part of the cache system 118. In one or more implementations, the side buffer 134 is deployed within the cache hierarchy 122. For example, the side buffer 134 is deployed before the memory controller 108 and after the coherency point of the system (e.g., the last level cache 128). In this example, because the side buffer 134 sits beyond the coherency point, changes to the existing cache hierarchy 122 are not required.

The side buffer 134 is capable of operating on any granularity. Moreover, the side buffer 134 is relatively small in terms of memory capacity so as not to incur large area/power overheads in the system 100, but also sufficiently large to hold prefetched data long enough for timely access. In one non-limiting example, the side buffer 134 is no more than 1 megabyte. In another non-limiting example, increasing the size of the side buffer 134 to 2 megabytes yields additional performance improvements (e.g., up to 15% with a fixed hit ratio of 30%).

Demand accesses to non-temporal regions take a conventional data path up until the side buffer 134. The side buffer 134 is looked up with a physical address, and requested bytes are retrieved on a hit. A response is sent back by filling the response packet with the requested bytes and padded with “0” for the rest of the fields.

Irregular prefetcher targets workloads (e.g., workloads from graph applications and applications with arrays of pointers) are highly sensitive to memory access latency. Exploiting memory-level parallelism to hide the latency is limited by the dependency chains between the loads. In addition, these applications typically have high L3 cache miss rates (e.g., up to 100 PTC) and ratios (e.g., up to 99% miss ratio) on large data sizes.

As mentioned above, data prefetched by the FG memory aware prefetcher 132 is stored in the side buffer 134. The side buffer 134 provides sufficient latency savings over accessing DRAM, and with a sufficient hit-rate, the side buffer 134 significantly boosts system performance. In experiments, implementation of the side buffer 134 is capable of achieving a hit-ratio of at least 30%, which results in significant performance improvements for many irregular workloads.

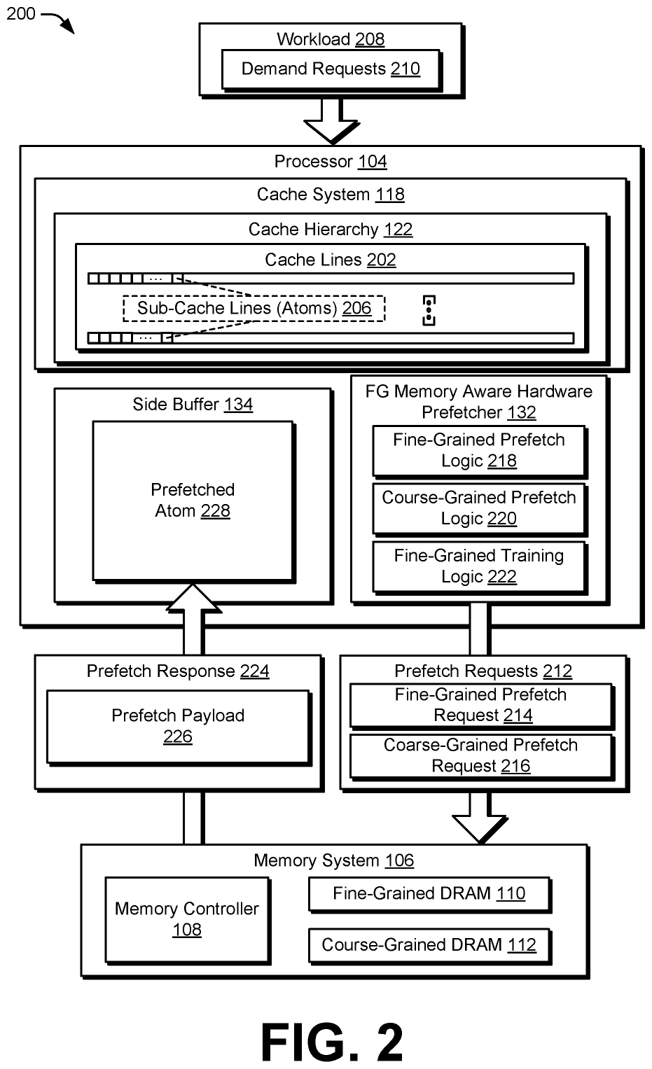

FIG. 2 is a block diagram of a non-limiting example 200 in which fine-grained prefetch logic issues fine-grained prefetch requests to a fine-grained memory, such as the FG-DRAM 110. As shown, the example 200 includes the processor 104, the cache system 118, the cache hierarchy 122, the FG memory aware prefetcher 132, the side buffer 134, the memory system 106, the memory controller 108, the FG-DRAM 110, and the CG-DRAM 112 introduced above in the discussion of FIG. 1. The cache hierarchy 122 is also illustrated as including a plurality of cache lines 202 where data is stored. The cache lines 202 are fixed size units of data. Conventionally, cache lines are 64 bytes, although alternative sizes such as 32 bytes and 128 bytes are contemplated. As such, the cache lines 202 are not limited to any specific size. Each of the cache lines 202 is depicted as being logically segmented into a plurality of sub-cache lines 204 (also referred to as “atoms”). The size of the sub-cache lines 204 (referred to herein as “the atom size”) is variable, with example atom sizes being 4 bytes, 8 bytes, 16 bytes, or 32 bytes.

The cache system 118 receives a workload 208 including demand requests 210 resulting in accesses to the cache hierarchy 122 to perform load and store operations. As mentioned above, the FG memory aware prefetcher 132 targets primarily irregular workloads. As such, the workload 208 is representative of irregular workloads with an access granularity of less than 64 bytes corresponding to a size of the sub-cache lines 206. The workload 208 is also representative of regular workloads with an access granularity of 64 bytes corresponding to the fixed size of the cache lines 202. In other words, the system 100 is configured to handle both irregular workloads and regular workloads, although in some implementations, the system 100 is configured to handle irregular workloads only.

The FG memory aware prefetcher 132 is configured to issue prefetch requests 212 towards the memory system 106. In particular, the FG memory aware prefetcher 132 issues fine-grained prefetch requests 214 to the FG-DRAM 110 and coarse-grained prefetch requests 216 to the CG-DRAM 112, via execution of fine-grained prefetch logic 218 and course-grained prefetch logic 220, respectively. The fine-grained prefetch requests 214 are generated by the fine-grained prefetch logic 218 and include prefetch requests that are specific to prefetches for data to be stored in the sub-cache lines 206 (e.g., <64 bytes). The fine-grained prefetch requests 214 are marked as non-temporal and include an additional field describing the size of the sub-cache lines 206. For example, the additional field includes up to two bits used to encode four different atom sizes—4 bytes, 8 bytes, 16 bytes, and 32 bytes. The coarse-grained prefetch requests 216 are generated by the course-grained prefetch logic 220 and include prefetch requests that are specific to prefetches for data to be stored in the cache lines 202 (e.g., 64 bytes). The coarse-grained prefetch requests 216 are marked as non-temporal if it is a prefetch to a non-temporal region. The coarse-grained prefetch requests 216 to a temporal region are regular prefetches that follow a conventional prefetch flow.

The FG memory aware prefetcher 132 is configured to selectively execute the fine-grained prefetch logic 218 or the course-grained prefetch logic 220 based on the nature of the workload 208. For example, if the workload 208 is or contains an irregular workload, the FG memory aware prefetcher 132 executes the fine-grained prefetch logic 218. Further, if the workload 208 is or contains a regular workload, the FG memory aware prefetcher 132 executes the course-grained prefetch logic 220. Alternatively, the course-grained prefetch logic 220 is executed by a different prefetcher, such as one of example prefetchers 130 described above.

The FG memory aware prefetcher 132 is also configured to execute a fine-grained training logic 222. The fine-grained training logic 222, when executed, causes the FG memory aware prefetcher 132 to perform sub-cache line (i.e., atom) training for non-temporal memory regions to avoid any complexity/issues from tracking fine-grained coherency and caching at a granularity of less than 64 bytes. The fine-grained training logic 222 adds additional training capabilities to the FG memory aware prefetcher 132 by enabling training on non-temporal accesses. Currently, conventional prefetchers do not train on non-temporal accesses and instead rely on cache hit/miss information for temporal accesses.

Current prefetchers typically implement some form of pattern detection by tracking which physical addresses that have been previously accessed and missed in the cache. The patterns (and previous accesses) are usually stored in some form of table, tagged by a program counter (PC) which caused the missing load. To add support for FG-aware prefetch training, the fine-grained training logic 222 tracks misses on a granularity smaller than 64 bytes. This is achieved by using a cache line offset and expanding the table entries with fields to track a last atom offset and an atom size (e.g., 4 bytes, 8 bytes, 16 bytes, or 32 bytes).

Responsive to the prefetch requests 212, the memory system 106 generates a prefetch response 224 including a prefetch payload 226. The prefetch payload 226 includes data obtained from the FG-DRAM 110 and/or the CG-DRAM 112 based upon the type of prefetch request 212. In the illustrated example, the prefetch payload 226 contains a prefetched atom 228 obtained from the FG-DRAM 110 responsive to the fine-grained prefetch request 214. The prefetched atom 228 is stored in the side buffer 134 for retrieval by the cache system 118 to be placed in one of the sub-cache lines 206 in the cache hierarchy 122.

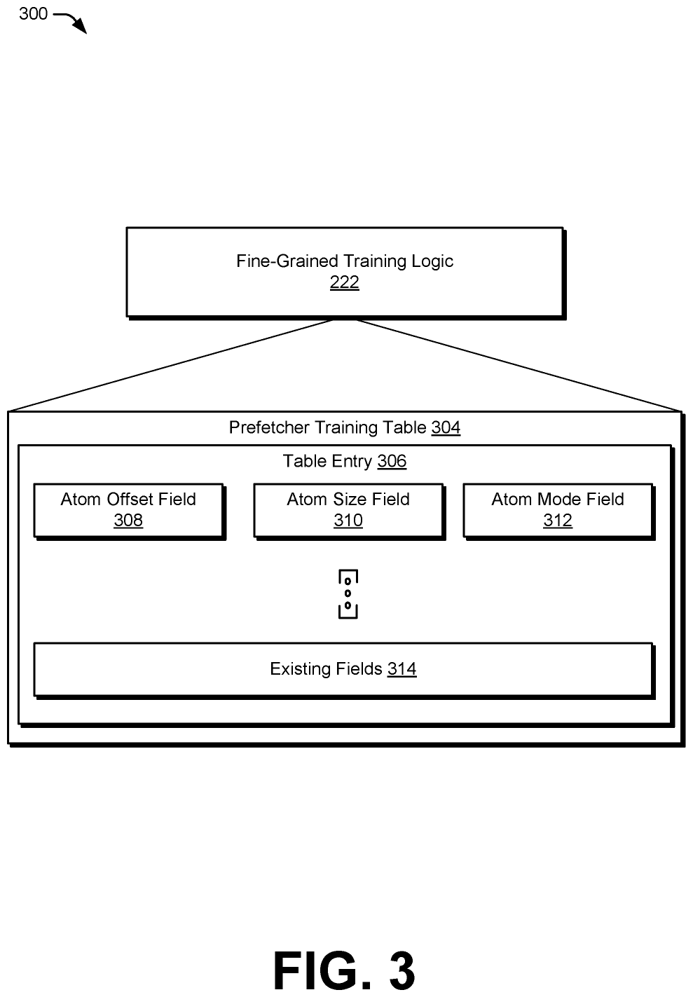

FIG. 3 depicts a non-limiting example 300 in which the fine-grained training logic 222 includes a prefetcher training table 304. In accordance with the techniques described herein, the prefetcher training table 304 is expanded to include additional fields that allow the fine-grained training logic 222 to leverage and issue atom-sized fetches with fine-grained memory aware support. In particular, the prefetcher training table 304 includes a table entry 306. The table entry 306 includes an atom offset field 308, an atom size field 310, and an atom mode field 312. The table entry 306 also includes existing fields 314, such as a program counter field, a last address field, a current stride field, a distance field, and a confidence counter field.

To add support for FG-aware prefetching, the prefetcher training table 304 adds a current atom size to the atom size field 310 and an atom offset (i.e., within a 64 byte cache line) to the atom offset field 308. Fetching less than 64 bytes can have a detrimental effect on system performance if spatial locality exists. For this reason, the fine-grained training logic 222 dynamically decides whether to train/issue prefetches for a particular atom size (e.g., <64 bytes) corresponding to the size of the sub-cache lines 206 or to train/issue prefetches on a 64 byte granularity. The atom mode field 312 instructs the fine-grained training logic 222 whether it should be training in a whole cache line mode (i.e., issue course-grained prefetch requests 216) or in a fine-grained mode (i.e., issue fine-grained prefetch requests 214). If there are more than one atom accessed within a cache line 202, the fine-grained training logic 222 fetches the whole cache line 202, whereas if there is only one atom and the FG memory aware prefetcher 132 has strided access, the fine-grained training logic 222 is trained to prefetch atoms using the stride generated by the FG memory aware prefetcher 132. The dynamic throttling of this training mode depends average cache line utilization, available system bandwidth, accuracy, or a combination thereof.

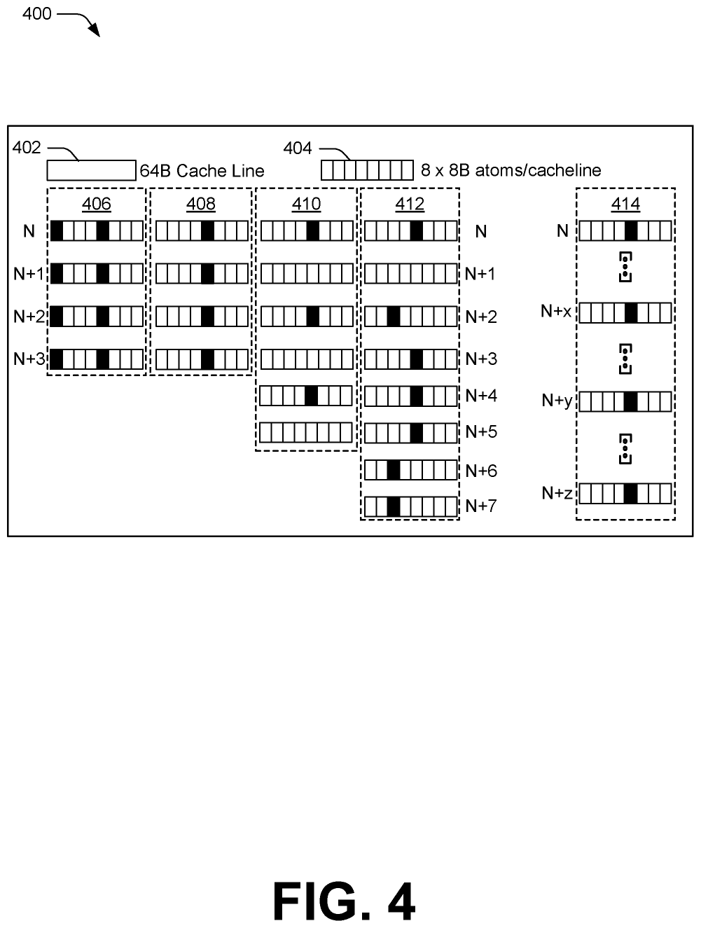

FIG. 4 depicts several examples (generally shown as 400) in which different 8 bytes accesses are detected by various prefetchers when extended with FG support. A 64 byte cache line 402 (e.g., the cache lines 202) is divided into eight 8 byte atoms 404 (e.g., the sub-cache lines 206). Various stride patterns 406, 408, 410 are depicted.

The stride pattern 406 has a stride of 32 bytes, in which case the default prefetch procedure is to prefetch all cache lines 402 (and default to a stream prefetch) or prefetch only 8 byte atoms 404 with an expanded FG stride prefetcher pattern with a stride of 64 bytes and 8 bytes are used from each cache line 402.

The stride pattern 408 has a stride of 64 bytes and only 8 bytes are used from each cache line 402. Such a case would be covered with either stream 64 byte prefetchers at the expense of wasting memory bandwidth and energy.

The stride pattern 410 is a typical stride pattern with a stride of 8 bytes requested for each cache line 402.

A region-based spatial prefetcher is capable of predicting similar patterns (shown as 412). A random pattern 414 of offsets is also shown. In one or more implementations, the random pattern 414 is used to design a dedicated offset prefetcher (or random pattern prefetcher) with dedicated support. Such an implementations simplifies design and verification of current state of the art core prefetchers.

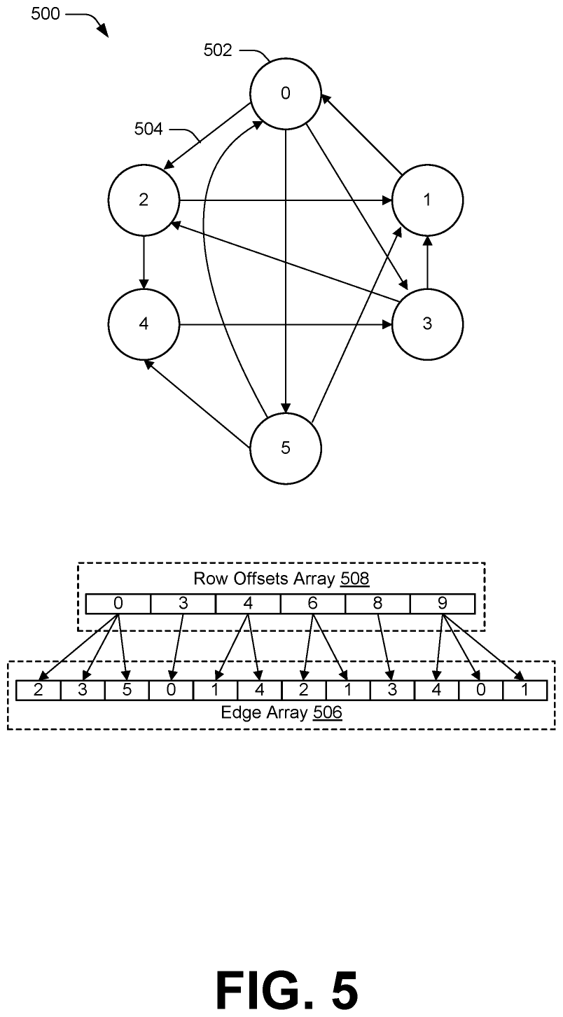

FIG. 5 depicts an example dynamic atom fetch granularity use case for depth first search (DFS). FIG. 5 makes a case for variable atom size in a graph analytics workload where a graph 500 is represented in the compressed row (CSR) format. The CSR format stores vertices 502 and edges 504 in separate arrays. An edge array 506 is sorted by the edges 504 and contains a target vertex from a source vertex. A row offsets array 508 stores a starting index of the corresponding node in the edge array 506. Hence, the number of edges 504 from a vertex 502 is obtained by taking a difference between Row_Offsets_Array [i+1]-Row_Offsets_Array[i]. For example, the first three elements in the edge array 506 represent the edges 504 from the first vertex “0” to the vertices “2,” “3,” and “5.”

A DFS algorithm would traverse one neighboring vertex edge at a time recursively before moving on to the next vertex edge. In such scenarios, the atom size should be limited to fetch the vertex edges that will be “near future,” recursively, compared to all the edges that may fall into a cache line of a neighboring edge. Consequently, it is advantageous to limit the atom size that fetches the first three elements of the edge array during the first fetch and to limit the atom size that fetches the next two elements that will be touched later in time. Accordingly, the FG-aware prefetcher 130 incorporates the atom size to change the fetch size that responds dynamically to graph input.

The following flowcharts describe a training process of a prefetcher with atom support, using an extended stride prefetcher example. The flowcharts will be described with the assumption that the prefetcher training table entries are extended to keep track of atom stride patterns (e.g., as shown in FIG. 3).

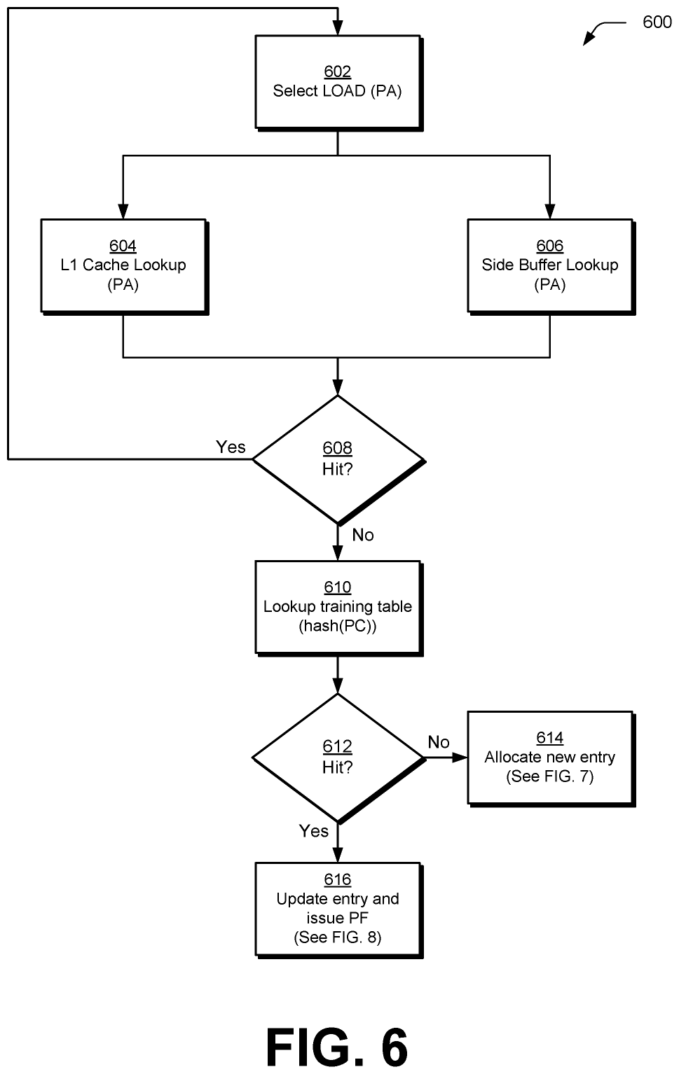

FIG. 6 depicts a procedure 600 in a non-limiting example implementation of training the FG memory aware prefetcher 132. The FG memory aware prefetcher 132 trains on cache misses at the L1 cache 124, for example. In the procedure 600, the fine-grained training logic 222 selects a load instruction (block 602). For each selected load instruction, the fine-grained training logic 222 performs a lookup operation on the L1 cache 124 to determine the physical address associated with the load instruction (block 604). Also, in parallel, the fine-grained training logic 222 performs a lookup operation on a scratchpad (e.g., the side buffer 134) (block 606) which potentially stores a previously prefetched atom (e.g., the prefetched atom 228).

If one of the lookup operations (blocks 602, 604) results in a hit (as determined at block 608), the fine-grained training logic 222 selects another load instruction (block 602) and the procedure 600 continues as described above. If one of the lookup operations (blocks 602, 604) results in a cache miss (as determined at block 608), the fine-grained training logic 222 performs a lookup operation on the prefetcher training table 304 (block 610) using the missing load or a hash of the program counter.

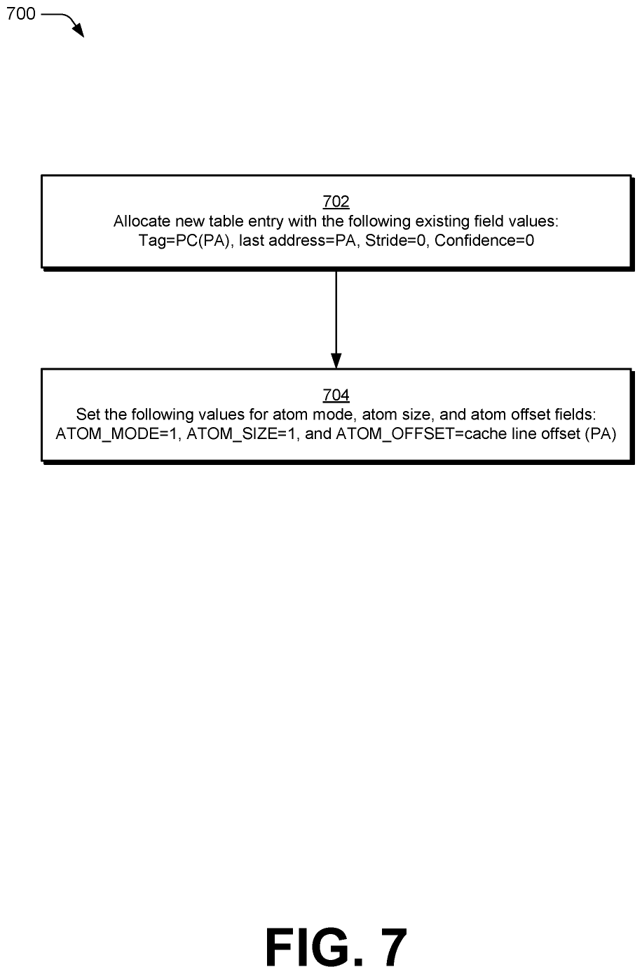

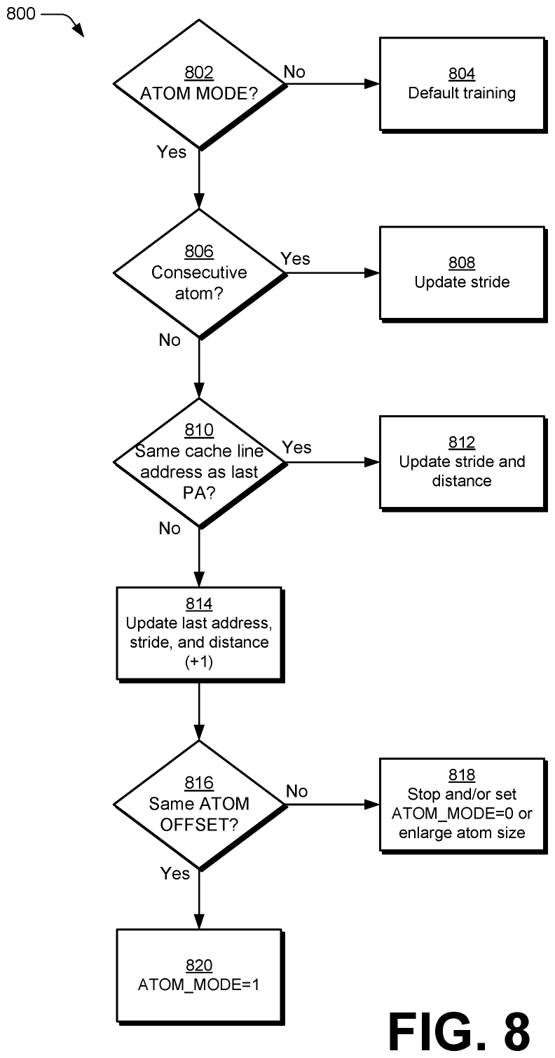

If the lookup operation (block 610) results in a miss (block 612), the fine-grained training logic 222 allocates a new table entry 306 in the prefetcher training table 304 (block 614) for the load instruction. Additional details in this regard are described below with reference to a procedure 700 depicted in FIG. 7. If, however, the loop operation (block 610) results in a hit (block 612), the fine-grained training logic 222 updates an existing table entry 306 in the prefetcher training table 304 (block 616). Additional details in this regard are described below with reference to a procedure 800 depicted in FIG. 8.

FIG. 7 depicts a procedure 700 for allocating a new table entry 306 in the prefetcher training table 304. The procedure 700 begins and a new table entry 306 is allocated in the prefetcher training table 304 and the existing fields 314 are initialized (block 702). For example, a tag field value is set to the program counter (physical address), a last address field value is set to the physical address, a stride field value is set to 0, and a confidence counter field value is set to 0. The fine-grained training logic 222 begins training strides in atom mode (i.e., the atom mode field 312 is set to “1”), the atom size field 310 is set to 1, and the atom offset field 308 is set to the cache line offset. The atom size field 310 value is expressed as a multiple of 8 bytes, and initially it is set to 1 if the triggering load requested is less than or equal to 8 bytes and it is set to a multiple greater than 8 bytes if the triggering load requested is greater than 8 bytes (e.g., for a 256-bit AVX LOAD is set to 4).

FIG. 8 depicts a procedure 800 for updating an existing table entry 306 in the prefetcher training table 304. The procedure 800 covers the scenarios when there is a hit in the prefetcher training table 304 and an existing table entry 306 is updated. First, the fine-grained training logic 222 checks whether the training mode is in atom mode (block 802). If not, the fine-grained training logic 222 continues training in a default training mode. For example, in stride prefetching mechanisms, the fine-grained training logic 222 updates the stride, the distance, and the last physical address. If atom mode is enabled, the fine-grained training logic 222 updates the stride and the distance values in context of the atom mode. To do so, the fine-grained training logic 222 covers two cases: (1) the case in which the space between two atoms is smaller than a cache line; and (2) the case in which the stride is at least one cache line apart.

When the atoms fall within the same cache line, the fine-grained training logic 222 also checks whether the atoms are consecutive (block 806). If so, the fine-grained training logic 222 updates the stride to be smaller than a cache line which results in both atoms being in the same cache line (block 808). If not, the fine-grained training logic 222 determines if the cache line has the same address as the last physical address (block 810). If so, the fine-grained training logic 222 updates the stride and the distance (block 812). If not, the fine-grained training logic 222 updates the last address, the stride, and the distance (block 814). The fine-grained training logic 222 then determines if the atoms have the same value in the atom offset field 308. If not, the fine-grained training logic 222 stops training and/or sets the atom mode field 312 to “0” or enlarges the atom size value in the atom size field 310. If so, the fine-grained training logic 222 changes the atom mode field 312 to “1.”

It will be understood that many variations are possible based on the disclosure herein. Although features and controls are described above in particular combinations, each feature or control is usable alone without the other features and controls or in various combinations with or without other features and controls.

The various functional units illustrated in the figures and/or described herein (including, where appropriate, the system 100, the device 102, the processor 104, the memory system 106, the memory controller 108, the FG-DRAM 110, the CG-DRAM 112, the execution units 114, the load-store units 116, the cache system 118, the registers 120, the cache hierarchy 122, the L1 cache 124, the L2 cache 126, the last level cache 128, the prefetcher 130, the FG memory aware prefetcher 132, the side buffer 134, the fine-grained prefetch logic 218, the course-grained prefetch logic 220, and the fine-grained training logic 222) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A processor comprising:
a cache comprising one or more cache lines, and the one or more cache lines comprising one or more sub-cache lines;
a side buffer associated with the cache, the side buffer configured to store prefetched sub-cache line data for storage in the one or more sub-cache lines; and
a fine-grained memory aware prefetcher configured to:
generate a fine-grained prefetch request identifying data to be prefetched from a fine-grained memory;
responsive to the fine-grained prefetch request, receive the data from the fine-grained memory; and
store the data in the side buffer as the prefetched sub-cache line data for retrieval by the cache.

2. The processor of claim 1, wherein the cache comprises a cache hierarchy comprising a level 1 cache, a level 2 cache, and a last level cache.

3. The processor of claim 2, wherein the side buffer is deployed between the fine-grained memory and the last level cache.

4. The processor of claim 3, wherein the prefetched sub-cache line data comprises a prefetched atom.

5. The processor of claim 4, wherein the prefetched atom has an atom size that is less than 64 bytes.

6. The processor of claim 5, wherein the fine-grained prefetch request identifies the atom size based on a size of the one or more sub-cache lines.

7. The processor of claim 1, wherein the fine-grained memory aware prefetcher is further configured to:
select a load instruction associated with the data to be prefetched;
perform a cache lookup in the cache for a physical address associated with the load instruction;
perform a side buffer lookup in the side buffer for the physical address associated with the load instruction; and
responsive to a hit in the cache lookup or the side buffer lookup, perform a prefetcher training table lookup in a prefetcher training table.

8. The processor of claim 7, wherein the fine-grained memory aware prefetcher is further configured to, responsive to a hit in the prefetcher training table lookup, updating an entry in the prefetcher training table.

9. The processor of claim 7, wherein the fine-grained memory aware prefetcher is further configured to, responsive to a miss in the prefetcher training table lookup, allocating a new table entry in the prefetcher training table.

10. A system comprising:
a fine-grained memory; and
a prefetcher configured to:
generate a fine-grained prefetch request identifying data to be prefetched from the fine-grained memory;
responsive to the fine-grained prefetch request, receive the data from the fine-grained memory; and
store the data in a side buffer for retrieval by a cache.

11. The system of claim 10, further comprising a processor including the side buffer, the cache, and the prefetcher, the cache comprising a cache hierarchy.

12. The system of claim 11, wherein the side buffer is deployed between the fine-grained memory and a last level cache of the cache hierarchy.

13. The system of claim 12, wherein the data comprises a prefetched atom.

14. The system of claim 13, wherein the prefetched atom has an atom size that is less than 64 bytes.

15. The system of claim 14, wherein the fine-grained prefetch request identifies the atom size based on a size of a sub-cache line within the cache.

16. The system of claim 10, wherein the prefetcher is further configured to:
select a load instruction associated with the data to be prefetched;
perform a cache lookup in the cache for a physical address associated with the load instruction;
perform a side buffer lookup in the side buffer for the physical address associated with the load instruction; and
responsive to a hit in the cache lookup or the side buffer lookup, perform a prefetcher training table lookup in a prefetcher training table.

17. The system of claim 16, wherein the prefetcher is further configured to, responsive to a hit in the prefetcher training table lookup, update an entry in the prefetcher training table.

18. The system of claim 16, wherein the prefetcher is further configured to, responsive to a miss in the prefetcher training table lookup, allocating a new table entry in the prefetcher training table.

19. A method comprising:
generating, by a prefetcher, a fine-grained prefetch request identifying data to be prefetched from a fine-grained memory;
responsive to the fine-grained prefetch request, receiving, by the prefetcher, the data from the fine-grained memory; and
storing, by the prefetcher, the data in a side buffer as prefetched sub-cache line data for retrieval by a cache.

20. The method of claim 19, further comprising:
selecting, by the prefetcher, a load instruction associated with the data to be prefetched;
performing, by the prefetcher, a cache lookup in the cache for a physical address associated with the load instruction;
performing, by the prefetcher, a side buffer lookup in the side buffer for the physical address associated with the load instruction;
responsive to a hit in the cache lookup or the side buffer lookup, performing, by the prefetcher, a prefetcher training table lookup in a prefetcher training table;
responsive to a hit in the prefetcher training table lookup, updating, by the prefetcher, an entry in the prefetcher training table; and
responsive to a miss in the prefetcher training table lookup, allocating, by the prefetcher, a new table entry in the prefetcher training table.
